(19) United States
(12) Patent Application Publication
(10) Pub. No.: US 2013/0030130 A1
(43) Pub. Date: Jan. 31, 2013

(54) METHOD FOR PRODUCING BLOCK POLYMER, BLOCK POLYMERS, AND SURFACE TREATMENT AGENT

(71) Applicants: Yutaka Ohhira, Settsu-shi (JP); Ikuo Yamamoto, Settsu-shi (JP)

(72) Inventors: Yutaka Ohhira, Settsu-shi (JP); Ikuo Yamamoto, Settsu-shi (JP)

(73) Assignee: DAIKIN INDUSTRIES LTD., Osaka-shi, Osaka (JP)

(21) Appl. No.: 13/578,523

(22) PCT Filed: Feb. 10, 2011
(86) PCT No.: PCT/JP2011/052810

§ 371 Date: Aug. 10, 2012

(30) Foreign Application Priority Data
Feb. 12, 2010 (JP) 2010-028866

(51) Int. Cl. C08G 63/91; C08G 63/87

(52) U.S. Cl. 525/451

(57) ABSTRACT

A method for producing block polymers which involves (i) a step for obtaining a polymer of first monomers by means of a first polymerization reaction to polymerize the first monomers in the presence of an alkoxyamine catalyst, and (ii) a step for obtaining a block polymer by means of a second polymerization reaction to polymerize second monomers in the presence of an alkoxyamine catalyst and the polymers of the first monomers, wherein at least one of the kinds of monomers is a fluorinated (meth)acrylate monomer.

### TECHNICAL FIELD

The present invention relates to a polymer and a treatment with the polymer which impart excellent water repellency, oil repellency and soil resistance to a textile, a masonry, an electrostatic filter, a dust protective mask, and a part of fuel cell.

### BACKGROUND ART

A nitroxide-based living radical polymerization attracts attention in the point that the good results are obtained not only for a styrene-based polymerization but also for an acrylate-based polymerization. However, the nitroxide has a defect as an initiator of copolymerization (Since a polymerization reaction is uncontrollable, this polymerization is an industrially unsatisfactory method), and 2-methyl-2-[N-(tert-butyl)-N-(diethoxyphosphoryl-2,2-dimethylpropyl)-aminoxy]propionic acid and the like are described as a conquerable initiator, as disclosed in JP-A-2005-534712 (Japanese Patent No. 4203820).

Moreover, JP-A-2007-520613 discloses a method of polymerizing at least one radically polymerizable monomer in the presence of a water-soluble alkoxyamine, as an emulsion, mini-emulsion, or micro-emulsion polymerization method. This method is used for manufacture of a multi-block polymer. Although poly(perfluoro octyl acrylate)-b-poly(stearyl methacrylate) is illustrated as this multi-block polymer, a perfluorooctyl acrylate is difficult to be manufactured and does not have an industrial use.

Macromolecules 2005, 38, 5485-5492 discloses a reaction mechanism (activation-deactivation equilibrium) of the nitroxide-based living radical polymerization. The reaction mechanism disclosed in this literature is supported, since a polymerization reaction further advances even if styrene is added after the living radical polymerization of MMA.

The fluorine-containing acrylate conventionally used as an active ingredient of a water- and oil-repellent agent is a perfluoroalkylethyl (meth)acrylate. The carbon number of a fluoroalkyl group of the fluorine-containing acrylate monomer practically used is usually at least 8.

Since the length of the fluoroalkyl chain is long, there is the defect that the fluorine-containing acrylate monomer is excessively hydrophobic. The excessive hydrophobicity has caused various problems on the preparation and properties of the fluorine-containing acrylate polymer.

Various recent research results indicate that in view of the practical treatment of fibers with the surface treatment agent (particularly the water- and oil-repellent agent), the important surface property is not a static contact angle, but is a dynamic contact angle, particularly a reversing contact angle. That is, the advancing contact angle of water is not dependent on the carbon number of the fluoroalkyl side chain, but the reversing contact angle of water in the case of carbon number of at most 7 is remarkably low than that in the case of carbon number of at least 8. In correspondence to this, an X ray analysis shows that the side chain crystallizes when the carbon number of side chain is at least 7. It is known that the actual water repellency has relationship with the crystallization of the side chain and that mobility of the surface treatment agent molecules is an important factor for expression of the actual performances (for example, MAEKAWA Takashige, FINE CHEMICAL, Vol. 23, No. 6, page 12 (1994)). Accordingly, it is believed that the acrylate polymer having low carbon number of fluoroalkyl group in the side chain which is at most 7 (particularly at most 6) has low crystallinity so that the polymer cannot satisfy the actual performances (particularly water repellency).

Recent study results (EPA Report “PRELIMINARY RISK ASSESSMENT OF THE DEVELOPMENTAL TOXICITY ASSOCIATED WITH EXPOSURE TO PERFLUOROOCTANOIC ACID AND ITS SALTS” (http://www.epa.gov/opptintr/pfoa/pfoara.pdf)) and the like clarify that a PFOA (perfluorooctanoic acid) doubtfully has a potential risk of environmental load. EPA (Environmental Protection Agency of USA) announced on Apr. 14, 2003 that the EPA intensifies the scientific investigation on PFOA.

On the other hand, Federal Register (FR Vol. 68, No. 73/Apr. 16, 2003 [FRL-2303-8]) (http://www.epa.gov/opptintr/pfoa/pfoafr.pdf), EPA Environmental News for release Monday April, 2003 “EPA INTENSIFIES SCIENTIFIC INVESTIGATION OF A CHEMICAL PROCESSING AID” (http://www.epa.gov/opptintr/pfoa/pfoaprs.pdf), and EPA OPPT FACT SHEET Apr. 14, 2003 (http://www.epa.gov/opptintr/pfoa/pfoafacts.pdf) announced that a “telomer” may possibly metabolize or decompose to PFOA.

It is also announced that the “telomer” is used in a large number of commercial products including fire fighting foams, care products and cleaning products as well as soil, stain and grease resistant coating on carpets, textiles, paper, and leather.

### PRIOR ARTS DOCUMENTS

### Patent Documents

Patent Document 1: JP-A-2005-534712 (Japan Patent No. 4203820)

Patent Document 2: JP-A-2007-520613

Non-patent Document 1: Macromolecules 2005, 38, 5485-5492

### DISCLOSURE OF INVENTION

### Problems to be Solved by the Invention

An object of the invention is to provide a fluorine-containing acrylate polymer which is excellent in water repellency, oil repellency, soil resistance, prevention ability of stain adhesion and mold releasability, in comparison with prior arts.

### Means for Solving the Problems

The present invention relates to a method for producing a block copolymer by polymerizing at least two monomers in the presence of an alkoxyamine catalyst, wherein at least one of the monomers is a fluorine-containing (meth)acrylate monomer.

The present invention provides a method for producing a block copolymer, which comprises steps of:
(i) conducting a first polymerization reaction which comprises polymerizing a first monomer in the presence of an alkoxyamine catalyst to give a polymer of the first monomer, and
(ii) conducting a second polymerization reaction which comprises polymerizing a second monomer in the presence of an alkoxyamine catalyst and the polymer of the first monomer to give the block polymer,
   wherein at least one of the monomers is a fluorine-containing (meth)acrylate monomer.

### Effects of the Invention

The present invention provides a fluorine-containing polymer which is a block copolymer having excellent glass transition temperature which is higher than the prior arts. The fluorine-containing polymer can be used as an active component of the surface treatment agent (e.g., a water- and oil-repellent agent, an antifouling agent, a mold release agent). Because the fluorine-containing polymer produced by the production method of the present invention has a high glass transition temperature, the surface treatment agent comprising the fluorine-containing polymer is superior in water repellency, oil repellency, soil resistance and mold releasability.

### MODES FOR CARRYING OUT THE INVENTION

The monomer to be polymerized is at least two types of monomers (the first monomer and the second monomer). Preferably, the monomer to be polymerized is at most five types of monomers or at most four types of monomers.

The monomers are preferably:
(1) at least two types of the fluorine-containing (meth)acrylate monomers (the first monomer and the second monomer), or
(2) at least one type of the fluorine-containing (meth)acrylate monomer (the first monomer) and at least one type of copolymerizable monomer (the second monomer).

In the present invention, the fluorine-containing (meth)acrylate monomer may be at least two types or may be one type.

The fluorine-containing (meth)acrylate monomer is preferably a monomer of the formula (I):

CH₂═C(—X)—C(═O)—O—Y-Rf (I)
wherein X represents a hydrogen atom, a methyl group, a fluorine atom, a chlorine atom, a bromine atom, an iodine atom, a CFX¹X² group
wherein X¹ and X² are a hydrogen atom, a fluorine atom or a chlorine atom, a cyano group, a linear or branched C₁ to C₂₁ fluoroalkyl group, a substituted or non-substituted benzyl group, or a substituted or non-substituted phenyl group;
Y is a C₁ to C₁₀ aliphatic group,
—(CH₂)ₖZ wherein k is an integer of 0 to 10, and Z is a C₆ to C₁₀ aromatic or cyclic aliphatic group,
a —N(R¹)(R²)SO₂— group wherein R¹ is a C₁ to C₁₀ alkyl group, and R² is a C₁ to C₁₀ alkylene group,
a —N(R¹)(R²)CO— group wherein R¹ is a C₁ to C₁₀ alkyl group, and R² is a C₁ to C₁₀ alkylene group,
a —CH₂CH₂CH₂—SO₂— group, or
a —CH₂CH(OY¹)CH₂— group wherein Y¹ is a hydrogen atom, a —OH group or a —OCOR⁴ group wherein R⁴ is a C₁ to C₄ alkyl group; and
Rf is a linear or branched C₁ to C₂₁ fluoroalkyl group.

In this general formula (I), a monomer wherein X is a methyl group is a fluorine-containing methacrylate monomer.

In the formula (I), particularly, Y may be a —CH₂CH₂N(R^{a})SO₂— group (wherein R^{a} is a C₁ to C₄ alkyl group) or may be a —CH₂CH(OCOCH₃)CH₂— group.

Examples of the fluorine-containing (meth)acrylate monomer includes (meth)acrylate esters of the formulas:

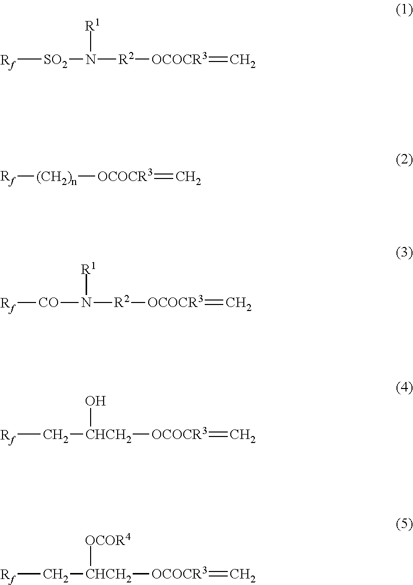

wherein Rf is a C₁₋₂₁ (e.g., C₃₋₂₁) perfluoroalkyl group or perfluoroalkenyl group,
R¹ is hydrogen or a C₁₋₁₀ alkyl group,
R² is a C₁₋₁₀ alkylene group,
R³ is a hydrogen atom, a methyl group, a fluorine atom, a chlorine atom, a bromine atom, an iodine atom, a CFX¹X² group (wherein X¹ and X² are a hydrogen atom, a fluorine atom or a chlorine atom), a cyano group, a linear or branched C₁ to C₂₁ fluoroalkyl group, a substituted or non-substituted benzyl group, or a substituted or non-substituted phenyl group,
R¹ is a C₁₋₄ alkyl group, and
n is an integer of 1 to 10.

In the above-mentioned formulas, the Rf group is preferably a perfluoroalkyl group. The number of carbon atoms of the Rf group is 1 to 21 and may be preferably 2 to 8, particularly 2 to 6. Examples of the Rf group include —CF₃, —CF₂CF₃, —CF₂CF₂CF₃, —CF(CF₃)₂, —CF₂CF₂CF₂CF₃, —CF₂CF(CF₃)₂, —C(CF₃)₃, —(CF₂)₄CF₃, —(CF₂)₂CF(CF₃)₂, —CF₂C(CF₃)₃, —CF(CF₃)CF₂CF₂CF₃, —(CF₂)₅CF₃, —(CF₂)₃CF(CF₃)₂, —(CF₂)₄CF(CF₃)₂, —(CF₂)₇CF₃, —(CF₂)₅CF(CF₃)₂, —(CF₂)₆CF(CF₃)₂ and —(CF₂)₉CF₃.

Specific examples of the fluorine-containing acrylate monomer and the fluorine-containing methacrylate monomer (X is a methyl group in general formula (I)) wherein alpha-position is not substituted are as follows:
CF3(CF₂)₇(CH₂)OCOCH═CH₂,
CF₃(CF₂)₆(CH₂)OCOC(CH₃)═CH₂,
(CF₃)₂CF(CF₂)₆(CH₂)₂OCOCH═CH₂,
CF₃(CF₂)₇(CH₂)₂OCOC(CH₃)═CH₂,
CF₃(CF₂)₇(CH₂)₂OCOCH═CH₂,
CF3CF₂(CH₂)₂OCOCH═CH₂,
CF₃(CF₂)₃ (CH₂)₂OCOCH═CH₂,
CF₃(CF₂)₇SO₂N(CH₃)(CH₂)₂OCOCH═CH₂,
CF₃(CF₂)₇SO₂N(C₂H₅)(CH₂)₂OCOC(CH₃)═CH₂,
CF₃(CF₂)₅SO₂(CH₂)₃OCOC(CH₃)═CH₂,
(CF₃)2CF(CF₂)₆CH₂CH(OCOCH₃)CH₂OCOC(CH₃)═CH₂,
(CF₃)₂CF(CF₂)₆CH₂CH(OH)CH₂OCOCH═CH₂,

In the a-substituted acrylate monomer, examples of the a-substituent include a halogen atom, an (e.g., C₁₋₂₁) alkyl group having a halogen atom substituted for a hydrogen atom (e.g., a monofluoromethyl group and a difluoromethyl group), a cyano group, and an aromatic group (for example, a substituted or unsubstituted benzyl group, a substituted or unsubstituted phenyl group).

Specific example of the fluorine-containing acrylate monomer having the alpha-substituted acrylate group (X is a substitute group other than the methyl group) are as follows:

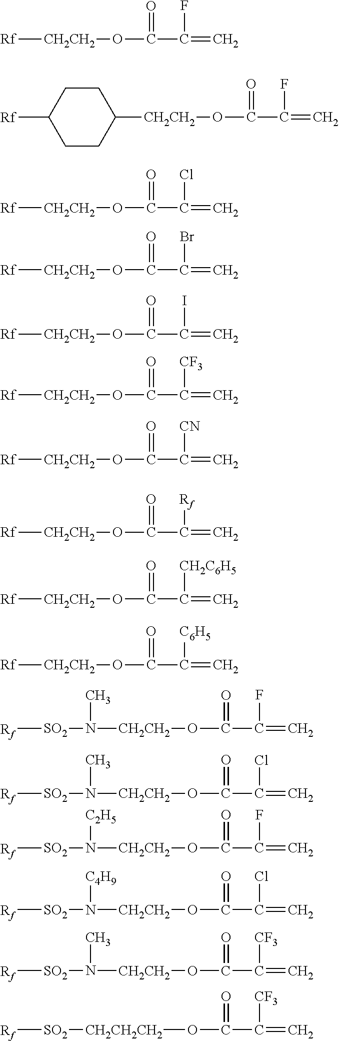

wherein Rf is a C₁₋₂₁ linear or branched perfluoroalkyl group or perfluoroalkenyl group.

In present invention, at least one (e.g., one or two) copolymerizable monomers may be used in addition to at least one (particularly one) fluorine-containing (meth)acrylate monomer. The copolymerizable monomer may be or may not be a fluorine-containing (meth)acrylate monomer. The copolymerizable monomer may be a fluorine-containing monomer, or may be a fluorine-free monomer. The copolymerizable monomer is preferably (1) the fluorine-free monomer alone, or (2) a combination of the fluorine-free monomer and the fluorine-containing monomer. The use of the copolymerizable monomer can contribute improvement of water-repellency of copolymer and the cost reduction of copolymer. When the copolymerizable monomer is the fluorine-containing monomer or comprises the fluorine-containing monomer, it is preferable for the number of carbon atoms of a fluorine-containing group such as a fluoroalkyl group (particularly a perfluoroalkyl group) in the fluorine-containing monomer (e.g., C₁₋₃) to be smaller than the number of carbon atom (e.g., C₄₋₂₁) of the fluoroalkyl group (particularly a perfluoroalkyl group) in the fluorine-containing (meth)acrylate monomer.

The copolymerizable monomer is various, and specific examples thereof include:
(1) Acrylic acid and methacrylic acid and esters thereof, e.g., methyl, ethyl, butyl, isobutyl, t-butyl, propyl, 2-ethyl hexyl, hexyl, decyl, lauryl, stearyl, isobornyl, behenyl, β-hydroxyethyl, glycidyl, phenyl, benzyl and 4-cyano phenyl esters,
(2) Vinyl esters of fatty acids such as acetic acid, propionic acid, caprylic acid, lauryl acid, stearic acid and behenic acid,
(3) Styrene-based compounds such as styrene, a-methyl styrene and p-methyl styrene,
(4) Vinyl or vinylidene halide compounds such as vinyl fluoride, vinyl chloride, vinyl bromide, vinylidene fluoride and vinylidene chloride,
(5) Aliphatic allyl esters such as allyl heptanoate, allyl caprylate and allyl caproate,
(6) Vinyl alkyl ketones such as vinyl methyl ketone and vinyl ethyl ketone,
(7) Acrylamides such as N-methyl acrylamide, N-methylol acrylamide and N-methylol methacrylamide, and
(8) Dienes such as 2,3-dichloro-1,3-butadiene and isoprene.

Furthermore, ethylene, acrylonitrile, polyethylene glycol(meth)acrylate, polypropylene glycol(meth)acrylate, methoxypolyethylene glycol(meth)acrylate, methoxypolypropylene glycol(meth)acrylate, vinyl alkyl ether and isoprene are exemplified.

The copolymerizable monomer is preferably a (meth)acrylate ester, particularly an alkyl ester of (meth)acrylic acid. The number of carbon atoms of the alkyl group may be from 1 to 30, for example, from 6 to 30, e.g., from 10 to 30. For example, the copolymerizable monomer may be (meth)acrylates of the general formula:

CH₂═CA¹COOA²

wherein A¹ is a hydrogen atom, a methyl group or a halogen atom, and A² is an alkyl group of CₙH₂ₙ₊₁ (n=1-30).

A halogen-containing monomer (particularly a monomer which contains chlorine or fluorine, e.g., vinyl chloride, vinylidene fluoride and tetrafluoroethylene) in addition to the fluorine-free monomer such as the (meth)acrylate ester may be used as the copolymerizable monomer.

For example, the amount of the copolymerizable monomer may be 1 to 300 parts by weight, e.g., 10 to 200 parts by weight, based on 100 parts by weight of the fluorine-containing (meth)acrylate monomer. When the copolymerizable monomer is a combination of the fluorine-free monomer and the fluorine-containing monomer, the weight ratio of a fluorine-free monomer to the fluorine-containing monomer may be 100:1 to 100:300, e.g., 100:10 to 100:200.

An average molecular weight of the prepared fluorine-containing copolymer, as measured by GPC, may be 1,000 to 10,000,000, e.g., 1,000 to 1,000,000.

The present invention uses the polymerization catalyst which can perform a living polymerization to form a polymer block. The polymerization catalyst used herein is an alkoxyamine and derivatives thereof.

The alkoxyamine is preferably a compound of the general formula:

R¹¹—O—N(—R²¹)(—R²²)

wherein each of R¹¹, R²¹ and R²² is independently a C₂₋₁₅ alkyl group, and R²¹ and R²² may be taken together to form a ring.

The number of carbon atoms in each of R¹¹, R²¹ and R²² may be preferably 3 to 12, particularly 4 to 10. Each of R¹¹, R²¹ and R²² may have an oxygen atom, a sulfur atom and/or a phosphorus atom.

The hydrogen atoms in each of R¹¹, R²¹ and R²² may be:
(A) replaced with a —COOR³¹ group (wherein R³¹ is a C₁-₁₅, particularly C₂₋₅ alkyl group) (particularly in R¹¹ group), and/or
(b) replaced with a O═P(OR³²)(OR³³)— group (wherein R³² and R³³ are independently a C₁₋₁₅, particularly C₂₋₅ alkyl group) (particularly in one or both of R²¹ and R²²).

When R¹¹ and R²¹ are taken together to form the ring, the number of carbon atoms of the ring may be 3 to 10, particularly 4 or 5 (e.g., cyclopentane ring) or 6 (e.g., cyclohexane ring).

Examples of the polymerization catalyst include the following alkoxyamine:

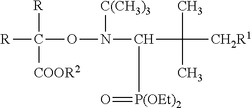

wherein each of R is, same or different, a C₁₋₃ linear or branched alkyl group,
R¹ represents a hydrogen atom or the following residue:

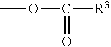

(wherein R³ represents a C₁₋₂₀ linear or branched alkyl group), and
R² represents a hydrogen atom, a C₁₋₈ linear or branched alkyl group, a phenyl group, an alkali metal or R²⁰₄N⁺ (wherein R²⁰ is, same or different, independently a hydrogen atom or a C₁₋₁₀ hydrocarbon group).

With reference to R², specific examples of the alkali metal include Li, Na and K. R²⁰ may be hydrogen or an alkyl group, and specific example of R²⁰₄N⁺ include H₄N⁺, Me₄N⁺, Me₃HN⁺, Et₄N⁺, Et₃HN⁺, Bu₄N⁺ and Bu₃HN⁺ (wherein Me is a methyl group, Et is an ethyl group, and Bu is a butyl group).

Specific examples of alkoxyamine includes the followings:

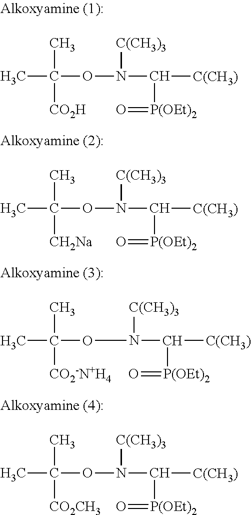

The amount of the polymerization catalyst may be 0.001 to 0.50 mol, e.g., 0.01 to 0.30 mol, based on 1 mol of the monomer.

The fluorine-containing polymer can be produced as follows:

The fluorine-containing polymer can be produced by heating (at e.g., 50 to 200° C. particularly 50 to 110° C.) the first monomer (particularly one or two copolymerizable monomers (the fluorine-free monomer or the fluorine-containing monomer)) in the presence of the polymerization catalyst to perform a single living polymerization (a first polymerization reaction) (a reaction time is, for example, 2 to 40 hours), and adding the second monomer (i.e., one or two fluorine-containing (meth)acrylate monomers) to perform a living polymerization (the temperature is, for example, 50 to 200° C. particularly 80 to 150° C.) in the presence of a polymerization catalyst (a second polymerization reaction) (a reaction time is , for example, 2 to 40 hours). The polymerization can be performed without using a polymerization initiator. Generally, the reaction temperature of the second polymerization is higher than the reaction temperature of the first polymerization (preferably by at least 10° C., more preferably by at least 20° C., e.g., by 20-80° C., particularly by 20-50° C.).

The fluorine-containing polymer of the present invention is the block copolymer which at least has a block A formed from a copolymerizable monomer (the fluorine-free monomer or the fluorine-containing monomer (particularly a fluorine-containing (meth)acrylate monomer)) and a block B formed from a fluorine-containing (meth)acrylate monomer. When both of the blocks A and B are formed from the fluorine-containing (meth)acrylate monomer, different types of the fluorine-containing (meth)acrylate monomers are used. That is, the fluorine-containing polymer prepared by a production method of the present invention is a block copolymer (block copolymers) having at least two (e.g., two types) blocks.

The glass transition temperature Tg of the resultant fluorine-containing polymer is higher than Tg of a fluorine-containing polymer produced by using a normal copolymerization method (e.g., a random copolymerization method). Therefore, according to the production method of the present invention, a ratio of fluorine in the polymers can be lowered to obtain a polymer having a high glass transition temperature Tg. The resultant fluorine-containing polymer can exhibit excellence in water repellency, oil repellency, soil resistance, stain adhesion prevention property and mold releasability. Therefore, according to the production method of the present invention, a polymer excellent in water repellency and the like can be obtained by using a (meth)acrylate monomer having the perfluoroalkyl group having at most 7 (particularly at most 6) carbon atoms in a side chain, as illustrated in a column of BACKGROUND ART.

Preferably the polymerization is conducted in absence of a solvent (water or an organic solvent). Alternatively, the polymerization may be conducted in the presence of a solvent. Preferably the boiling point (at 1 atm) of the solvent is high and may be, for example, at least 80° C., particularly at least 150° C., especially 160 to 300° C. The solvent may be a compound having a fluorine atom. The solvent can be used in the amount of 10 to 2000 parts by weight, e.g., 50 to 1000 parts by weight, based on 100 parts by weight of total of the monomer.

The fluorine-containing polymer produced by the production method of the present invention can be used as an active component of a surface treatment agent, e.g., a water- and oil-repellent agent, a soil release agent or a mold release agent. Therefore, the present invention provides the surface treatment agent comprising, as active component, a polymer produced by the production method of the present invention.

The surface treatment agent of the present invention is preferably in the form of a solution, an emulsion or an aerosol. The surface treatment agent generally comprises the fluorine-containing polymer and a medium (particularly a liquid medium, for example, an organic solvent and/or water). The concentration of the fluorine-containing polymer in the surface treatment agent may be, for example, from 0.01 to 50% by weight.

The surface treatment agent can be applied to a substrate to be treated by a know procedure. Usually, the surface treatment agent is diluted or dispersed with an organic solvent or water, is adhered to surfaces of the substrate by a well-known procedure such as an immersion coating, a spray coating and a foam coating, and is dried. If necessary, the surface treatment agent is applied together with a suitable crosslinking agent, followed by curing. It is also possible to add other surface treatment agents (for example, a water repellent agent and an oil repellent agent), or mothproofing agents, softeners, antimicrobial agents, flame retardants, antistatic agents, paint fixing agents, crease-proofing agents, etc. to the surface treatment agent of the present invention. For the immersion coating, the concentration of the fluorine-containing polymer in the treatment liquid contacted with the substrate may be from 0.05 to 10% by weight, based on the treatment liquid. For the spray coating, the concentration of the fluorine-containing polymer in the treatment liquid may be from 0.1 to 5% by weight, based on the treatment liquid. A stain blocker may be used. When the stain blocker is used, it is preferable to use an anionic emulsifier or a nonionic surfactant.

The substrate to be treated with the surface treatment agent (for example, a water- and oil-repellent agent) of the present invention include a textile (a yarn, a knitted fabric, a woven fabric, a nonwoven fabric, and a clothing, bedding, curtain, carpeting made by using these), masonry, a filter (for example, an electrostatic filter), a dust protective mask, a part of fuel cell (for example, a gaseous diffusion electrode and a gaseous diffusion support), glass, paper, wood, leather, fur, asbestos, brick, cement, metal and oxide, ceramics, plastics, a coated surface and a plaster. The textile may be particularly a carpet.

A fiber suitable for treating with the surface treatment agent of the present invention can include various types of examples. Examples of the textile include animal- or vegetable-origin natural fibers such as cotton, hemp, wool and silk; synthetic fibers such as polyamide, polyester, polyvinyl alcohol, polyacrylonitrile, polyvinyl chloride and polypropylene; semi-synthetic fibers such as rayon and acetate; inorganic fibers such as glass fiber, carbon fiber and asbestos fiber; and a mixture of these fibers. Since the treatment agent of the present invention excels in resistance against a detergent solution and a brushing (mechanical), the treatment agent of the present invention can be suitably used for a carpet made from nylon or polypropylene.

A stage of performing the surface treatment of textiles may be any of stages. That is, the application of the surface treatment agent may be conducted to the any of forms such as a fiber, a yarn and a cloth. When the carpet is treated with the surface treatment agent of the present invention, the carpet may be formed after treating fibers or yarns with the surface treatment agent, or the formed carpet may be treated with the surface treatment agent.

The “treatment” means that a treatment agent is applied to a substrate by immersion, spraying, coating or the like. The treatment gives the result that a fluorine-containing polymer which is an active component of the treatment agent is penetrated into internal parts of the substrate and/or adhered to surfaces of the substrate.

### EXAMPLES

The following Examples are specifically illustrated but are not to be construed to limit the scope of the invention.

### Water-Repellency Evaluation

The water repellency is represented by the water-repellency number by a spray process of evaluation method JIS L-1092. The relationship between the water-repellency number and the state after the spray is shown in the following Table 1.

TABLE 1

| Water repellency No. | State |
|---|---|
| 100 | No wet adhesion on surface |
| 90 | Slight wet adhesion on surface |
| 80 | Partial wet on surface |
| 70 | Wet on surface |
| 50 | Wet on whole surface |
| 0 | Full wet on front and back whole surfaces |

Polymers were Synthesized as Follows:

### Preparative Example 1

### Synthesis of Block Copolymer of poly(stearyl acrylate)-poly(3,3,4,4,5,5,6,6,7,7,8,8,8-tridecafluorooctyl acrylate):

According to the following formula, a polymer was synthesized:

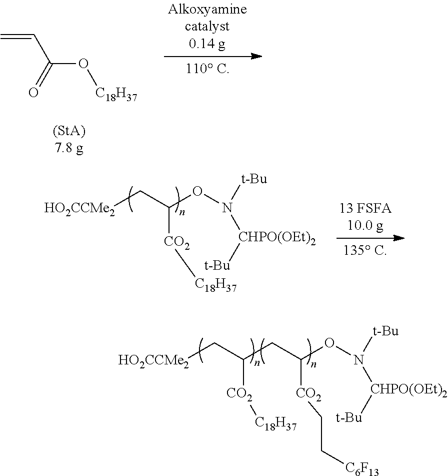

Specifically, stearyl acrylate (StA) (7.8 g (24mmol)) was charged in a 100 ml four-necked reaction flask, and an alkoxyamine catalyst (140 mg (0.35 mmol)) was added. A reflux condenser was equipped and the flask was bubbled with nitrogen for 20 minutes under warming to 40° C. The alkoxyamine catalyst used herein was of the formula:

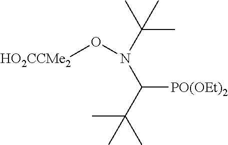

This compound is described in Macromolecules, 2005, 38, 5485-5492.

Immediately after stopping the bubbling, a babbling tube was changed to a balloon filled with nitrogen, and the mixture was stirred for 20 hours while heating to 110° C. over an oil bath. The mixture was cooled to room temperature, and 3,3,4,4,5,5,6,6,7,7,8,8,8-tridecafluorooctyl acrylate (13FSFA) (10 g (24 mmol)) was added to a solidified mixture. The mixture was caused to be a homogeneous solution at approximately 60° C., the bubbling of nitrogen was again performed (for 20 minutes) and the babbling tube was again changed to a balloon filled with nitrogen, and stirred under heating at 135° C. for 12 hours (A stir bar in the flask could not rotate after two hours, and the heating was continued). The mixture was cooled to room temperature and a precipitated solid was washed twice with 50 ml of methanol. An insoluble solid was vacuum dried to give a fluorine-containing polymer (a block copolymer) (17.3 g (Yield 97.2%)) as a light yellow solid.

Analysis results of the resultant fluorine-containing polymer are shown below.

¹H-NMR (THF-d₈,TMS)(ppm): δ 4.3 (bs, 2H, OCH₂), 4.0 (bs, 2H, OCH₂), 1.6 (bs, 2H, CH₂Me), 1.3 (bs, 30H, CH₂×15), 0.9 (bt, 3H, CH₃).

¹³F-NMR (THF-d₈, CFCl₃) (ppm):δ −81.3 (s, 3F, CF₃), −113.9 (s, 2F, CF₂), −122.1 (s, 2F, CF₂), −123.2 (s, 2F, CF₂), −123.8 (s, 2F, CF₂), −126.7 (s, 2F, CF₂).

A glass transition temperature of the block copolymer obtained by the above-mentioned method was 52.2° C. This glass transition temperature was Tg which was higher than existing StA-13FSFA-based polymers and polymers prepared by an ATRP method (Atom transfer radical polymerization method).

### Preparative Example 2

### Synthesis of Block Copolymer of poly(stearyl methacrylate)-poly(3,3,4,4,5,5,6,6,7,7,8,8,8-tridecafluorooctyl acrylate):

Stearyl acrylate (StA) (7.8 g (24 mmol)) was charged in a 100 ml four-necked reaction flask, and the alkoxyamine catalyst (140 mg (0.35 mmol)) which was the same as in Preparative Example 1 was added. A reflux condenser was equipped and the flask was bubbled with nitrogen for 20 minutes under warming to 60° C. Immediately after stopping the bubbling, a babbling tube was changed to a balloon filled with nitrogen, and the mixture was stirred for 20 hours while heating to 110° C. over an oil bath. The mixture was cooled to room temperature, and 3,3,4,4,5,5,6,6,7,7,8,8,8-tridecafluorooctyl methacrylate (13FSFMA) (10 g (23 mmol)) was added to a solidified mixture. The mixture was caused to be a homogeneous solution at approximately 70° C. , the bubbling of nitrogen was again performed (for 20 minutes) and the babbling tube was changed to a balloon filled with nitrogen, and stirred with heating at 135° C. for 18 hours (A stir bar in the flask could not rotate after two hours, and the heating was continued). The mixture was cooled to room temperature and a precipitated solid was washed twice with 50 ml of methanol. An insoluble solid was vacuum dried to give a fluorine-containing polymer (17.7g (Yield 99.4%)) as a light yellow solid. A glass transition temperature Tg of the resultant fluorine-containing polymer was 53° C.

### Preparative Example 3

### Synthesis of Block Copolymer of poly(behenyl acrylate)-poly(3,3,4,4,5,5,6,6,7,7,8,8,8-tridecafluorooctyl acrylate):

Behenyl acrylate (BehA) (7.8 g (21 mmol)) was charged in a 100 ml four-necked reaction flask, and the alkoxyamine catalyst (140 mg (0.35 mmol)) which was the same as in Preparative Example 1 was added. A reflux condenser was equipped and the flask was bubbled with nitrogen for 20 minutes under warming to 60° C. Immediately after stopping the bubbling, a babbling tube was changed to a balloon filled with nitrogen, and the mixture was stirred for 20 hours while heating to 110° C. over an oil bath. The mixture was cooled to room temperature, and 3,3,4,4,5,5,6,6,7,7,8,8,8-tridecafluorooctyl methacrylate (13FSFMA) (10 g (23 mmol)) was added to a solidified mixture. The mixture was caused to be a homogeneous solution at approximately 70° C. , the bubbling of nitrogen was again performed (for 20 minutes) and the babbling tube was changed to a balloon filled with nitrogen, and stirred with heating at 135° C. for 12 hours (A stir bar in the flask could not rotate after two hours, and the heating was continued). The mixture was cooled to room temperature and a precipitated solid was washed twice with 50 ml of methanol. An insoluble solid was vacuum dried to give a fluorine-containing polymer (17.0 g (Yield 95.5%)) as a light yellow solid. A glass transition temperature Tg of the resultant fluorine-containing polymer was 57° C.

### Preparative Example 4

### Synthesis of Block Copolymer of poly(stearyl acrylate)-poly(3,3,4,4,5,5,6,6,7,7,8,8,8-tridecafluorooctyl acrylate):

The polymer was synthesized according to the following formula:

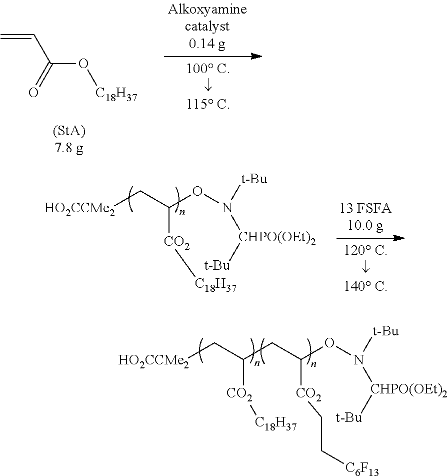

Stearyl acrylate (StA) (7.8 g (24 mmol)) was charged in a 100 ml four-necked reaction flask, and an alkoxyamine catalyst (140 mg (0.35 mmol)) was added. A reflux condenser was equipped and the flask was bubbled with nitrogen for 20 minutes under warming to 40° C. The alkoxyamine catalyst used herein was of the formula:

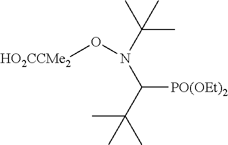

Immediately after stopping the bubbling, a babbling tube was changed to a balloon filled with nitrogen, and the mixture was stirred for 2 hours after heated to 100° C. over an oil bath. Subsequently, the mixture was stirred over 12 hours at 110° C. , and over 2 hours at 115° C. The mixture was cooled to room temperature, and 3,3,4,4,5,5,6,6,7,7,8,8,8-tridecafluorooctyl acrylate (13FSFA) (10 g (24 mmol)) was added to a solidified mixture. The mixture was caused to be a homogeneous solution at approximately 60° C. , the bubbling of nitrogen was again performed (for 20 minutes) and the balloon was changed to a balloon filled with nitrogen, and stirred with heating at 120° C. for 2 hours. The mixture was heated at 130° C. for 12 hours (A stir bar in the flask could not rotate after two hours, and the heating was continued) and finally heated at 140° C. for 2 hours. The mixture was cooled to room temperature and a precipitated solid was washed twice with 50 ml of methanol. An insoluble solid was vacuum dried to give a fluorine-containing polymer (a block copolymer) (17.5 g (Yield 97.5%)) as a light yellow solid.

A glass transition temperature Tg of the obtained fluorine-containing polymer was 52° C.

### Comparative Preparative Example 1

### Poly(stearyl acrylate)-poly(3,3,4,4,5,5,6,6,7,7, 8,8,8-tridecafluorooctyl acrylate)synthesis (Synthesis of Usual Random Copolymer):

3,3,4,4,5,5,6,6,7,7, 8,8,8-tridecafluorooctyl acrylate (13FSFA) (7.00 g (16.7 mmol)), and stearyl acrylate (StA) (3.00 g (9.2 mmol)) were charged into a 200-ml three-necked flask. Furthermore, butyl acetate (40 g) was added, and nitrogen gas bubbling was performed for 1 hour under stirring of THREE-ONE MOTOR. Then, the mixture was heated at 60° C. A solution of PERBUTYL PV (70%) (0.16 g (0.8 mmol)) in 1 ml of butyl acetate was added with stirring at 60° C. The mixture was stirred under nitrogen atmosphere at the same temperature for 6 hours. GC confirmed that the monomer had disappeared. The mixture was cooled to room temperature, the reaction mixture was poured into 150 ml of methanol, and the solvent was removed by decantation with ice cooling. An insoluble substance was washed again with 20 ml of methanol under ice cooling, and a white solid was vacuum dried to give a random copolymer (9.0 g (Yield 90.0%)). A glass transition temperature of the random copolymer was 25° C.

A ratio of the monomers and a ratio of fluorine contained in the obtained polymers used in Preparative Example 1 and Comparative Preparative Example 1 are shown in Table 2.

TABLE 2

| | | | Comparative |
|---|---|---|---|
| | | Preparative | Preparative |
| | | Example 1 | Example 1 |
| | | (Block | (Random |
| | | polymerization) | polymerization) |
| Monomer | 13FSFA (g) | 10.00 g | 7.00 |
| | | (=5.62) | |
| | StA (g) | 7.80 g | 3.00 |
| | | (=4.38) | |
| F content (wt %) | | 33.07 | 41.34 |

Note)
Inside of a parenthesis is amount (g), when the total monomer is converted into 10 g.

### Example 1

The soil release agent (1.0 g) prepared by Preparative Example 1 and THF (99 g) were mixed to obtain a treatment liquid. A cotton twill cloth was immersed in this treatment liquid, and the cloth was squeezed with a roll to give a wet pickup of 47mass %. Subsequently, the water- and oil-repellent treatment was completed by drying the cloth for 2 minutes at 110° C. , and also heat-treating for 2 minutes at 160° C. The water repellency of the cloth was measured. Results are shown in Table 3.

The water- and oil-repellent treatment was subjected also to other types of cloths. The used cloth, and treatment temperature and processing time were as follows.

Mixed twill cloth of 65% polyester and 35% cotton (heating 110° C. , 2 minutes→160° C., 2 minutes)

PET tropical cloth (white) (heating 110° C., 2 minutes→170° C. , 1 minute)

Nylon taffeta cloth (white) (heating 110° C., 2 minutes→170° C. , 1 minute) Results are shown in Table 3.

### Comparative Example 1

The water- and oil-repellent treatment was subjected to four types of cloth with the same procedure as in Example 1 using the fluorine-containing polymer obtained by Comparative Preparative Example 1.

Results are shown in Table 3.

TABLE 3

| | | Comparative |
|---|---|---|
| Type of cloth | Example 1 | Example 1 |
| Cotton twill | 50+ | 50 |
| Mixed twill of polyester/cotton | 70 | 70+ |
| PET tropical (white) | 80 | 70+ |
| Nylon taffeta (white) | 90+ | 90+ |

Although the fluorine content of the fluorine-containing polymer used in Example 1 was smaller than the fluorine content of the fluorine-containing polymer used in Comparative Example 1, Example 1 exhibits water repellency equivalent to or better than Comparative Example 1, depending on the type of cloth, as shown in Table 3, since the fluorine-containing polymer used in Example 1 had the high glass transition temperature Tg.

### INDUSTRIAL AVAILABILITY

The present invention provides a fluorine-containing polymer which is a block copolymer having a higher glass transition temperature as compared with conventionally obtained polymers. Since the fluorine-containing polymer obtained has a higher glass transition temperature, the fluorine-containing polymer is excellent in water repellency, oil repellency, antifouling property, and mold-releasability. Therefore, the fluorine-containing polymer obtained by the production method of the present invention can be used as an active ingredient of a surface treatment agent (for example, a water- and oil-repellent agent, a stain proofing agent, and a mold release agent).

1. A method for producing a block copolymer, which comprises steps of:
(i) conducting a first polymerization reaction which comprises polymerizing a first monomer in the presence of an alkoxyamine catalyst to give a polymer of the first monomer, and
(ii) conducting a second polymerization reaction which comprises polymerizing a second monomer in the presence of an alkoxyamine catalyst and the polymer of the first monomer to give the block polymer,
wherein at least one of the monomers is a fluorine-containing (meth)acrylate monomer.

2. The method according to claim 1, wherein the monomers are:
(1) at least two fluorine-containing (meth)acrylate monomer, or
(2) at least one fluorine-containing (meth)acrylate monomer and at least one copolymerizable monomer.

3. The method according to claim 1, wherein the fluorine-containing (meth)acrylate monomer is of the formula (I):
CH₂═C(—X)—C(═O)—O—Y—Rf (I)
wherein X represents a hydrogen atom, a methyl group, a fluorine atom, a chlorine atom, a bromine atom, an iodine atom, a CFX¹X² group
wherein X¹ and X² are a hydrogen atom, a fluorine atom or a chlorine atom,
a cyano group, a linear or branched C₁ to C₂₀ fluoroalkyl group, a substituted or non-substituted benzyl group, or a substituted or non-substituted phenyl group;
Y is a C₁ to C₁₀ aliphatic group,
a C₆ to C₁₀ aromatic or cyclic aliphatic group,
a —CH₂CH₂N(R¹)SO₂— group wherein R¹ is a C₁ to C₄ alkyl group,
a —CH₂CH(OY¹)CH₂— group wherein Y¹ is a hydrogen atom or a C₁ to C₄ acetyl group; and
Rf is a linear or branched C₁ to C₂₁ fluoroalkyl group.

4. The method according to claim 2, wherein the copolymerizable monomer is (meth)acrylates of the general formula:
CH₂═CA¹COOA²
wherein A¹ is a hydrogen atom or a methyl group, and
A² is an alkyl group of CₙH₂ₙ₊₁ in which n is 1-30.

5. The method according claim 1, wherein the alkoxyamine catalyst is a compound of the general formula:
R¹¹—O—N(—R²¹)(—R²²)
wherein each of R¹¹, R²¹ and R²² is independently a C₂₋₁₅ alkyl group, and R²¹ and R²² may be taken together to form a ring.

6. The method according claim 1, wherein the alkoxyamine catalyst is a compound of the formula: 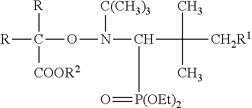
wherein each of R is, same or different, C₁₋₃ linear or branched alkyl groups,
R¹ represents a hydrogen atom or the following residue: 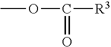
wherein R³ represents a C₁₋₂₀ linear or branched alkyl group.
R² represents a hydrogen atom, a C₁₋₈ linear or branched alkyl group, a phenyl group, an alkali metal or R²⁰₄N⁺ wherein R²⁰ is, same or different, independently a hydrogen atom or a C₁₋₁₀ hydrocarbon group.

7. The method according toclaim 1, wherein the steps (i) and (ii) are conducted in the absence of a solvent.

8. The method according to claim 1, wherein the polymerization is conducted by heating so that a reaction temperature of the second polymerization is higher by at least 20° C. than a reaction temperature of the first polymerization.

9. A polymer obtained by the method according to claim 1.

10. A surface treatment agent comprising, as an active ingredient, the polymer according to claim 9.

11. The surface treatment agent according to claim 10, which is a water- and oil-repellent agent, a stain proofing agent, or a mold release agent.

12. A method of treating a substrate, which comprises using the surface treatment agent according to claim 11.

13. A substrate treated by the method according to claim 12.
